(19) United States
(12) Patent Application Publication
(10) Pub. No.: US 2021/0216662 A1
(43) Pub. Date: Jul. 15, 2021

(54) DATA MANAGEMENT METHOD, DATA MANAGEMENT SYSTEM, AND TERMINAL

(71) Applicant: HITACHI, LTD., Tokyo (JP)

(72) Inventor: Kentarou WATANABE, Tokyo (JP)

(73) Assignee: HITACHI, LTD., Tokyo (JP)

(21) Appl. No.: 17/143,262

(22) Filed: Jan. 7, 2021

(30) Foreign Application Priority Data
Jan. 10, 2020 (JP) 2020-002591

(51) Int. Cl. G06F 21/62; G06F 3/06

(52) U.S. Cl. CPC G06F 21/6227; G06F 3/0655; G06F 3/067; G06F 3/0622

(57) ABSTRACT

An object of the present invention is to enable compliance with a data protection policy defined in a data source when a data processing process is performed in cooperation with plural autonomous distributed organizations. In a data management system, a peer node as a terminal executes a data storage process in which the necessity of protection of data obtained from a predetermined data source is determined on the basis of a data protection policy provided from the data source, and in the case where it is determined that the data requires protection, a reference address of the data is stored into a trust data storage area through a cooperation process among the terminals, and correspondence information between the reference address and the data is stored into a non-trust data storage area without performing the cooperation process.

### CROSS-REFERENCE TO RELATED APPLICATION

This application claims priority pursuant to Japanese patent application No. 2020-002591, filed on Jan. 10, 2020, the entire disclosure of which is incorporated herein by reference.

### BACKGROUND

The present invention relates to a data management method, a data management system, and a terminal.

Recently, business development through open innovation has become more common. As this trend continues, it is expected that plural autonomous organizations will cooperate with each other to form an ecosystem in which each organization will provide and use services.

Therefore, in order to form and develop an ecosystem as described above, it is necessary to establish a mechanism to evaluate scores for services and users in cooperation among organizations. In the case where a system for such score evaluation is realized, data is collected from various data sources, and score evaluation is performed in a cooperative manner on the basis of the collected data.

As prior art related to such score evaluation, proposed is, for example, a credit score management system (refer to Japanese Patent No. 6514813) for managing information used for evaluating the credibility of an individual that includes: a credit score management server that calculates the credit score of a user; and a user terminal that provides information for calculating the credit score to the credit score management server. The credit score management server includes: an input information acquisition unit that acquires information of a parameter input to a format displayed on the user terminal; an action history acquisition unit that continuously acquires, from the user terminal, information of the action history of the user transmitted when a signal indicating that the user has performed a predetermined action is detected; and a credit score calculation unit that calculates the credit score on the basis of the information of the parameter and the action history. The credit score calculation unit determines at least one of whether or not the user has started to habituate a predetermined action and the degree of habituation of the predetermined action on the basis of the information of the action history continuously acquired to calculate the credit score on the basis of the determination result.

As prior art related to data protection policy control in an edge-core storage system, proposed is a storage network system (refer to Japanese Patent No. 5592493) in which plural edges are connected to a core and a computer device is connected to at least one of the plural edges and that includes: a first storage system configuring each of the plural edges; a second storage system configuring the core; and a communication path connecting the plural first storage systems to the second storage system. The first storage system includes: a first storage device having plural hierarchies for storing first data transmitted from the computer device; and a first storage control device that defines a form for storing the first data into the plural hierarchies of the first storage device and executes control for the first data on the basis of a first policy including a storage capacity in each hierarchy of the first storage device. The second storage system includes: a second storage device having plural hierarchies for storing second data including backup data of the first data; and a second storage control device that defines a form for storing the second data into the plural hierarchies of the second storage device and executes control for the second data on the basis of a second policy including a storage capacity in each hierarchy of the second storage device. The second storage control device acquires the first policy from the plural edges, obtains a ratio of the storage capacity of an edge newly connected to the core to the total storage capacity of the plural edges from the first policy for each hierarchy of the plural hierarches of the second storage device, applies the ratio to the free capacity of the storage area of the core, obtains an allocated amount of the storage capacity of the second storage device to the edge newly connected to the core, and changes the second policy on the basis of the amount.

As prior art related to consensus building of distributed transactions in plural nodes configuring a blockchain, proposed is a data providing system (refer to Japanese Unexamined Patent Application Publication No. 2018-195154) that includes: a terminal that provides data; a gateway that selects and transmits the data by access control on the basis of a predetermined policy; and a service module that receives the data selected by the gateway and transfers the data to an application in response to a request from the application. The gateway stores information of the data and the terminal as the providing source of the data into a blockchain, and the service module verifies, when receiving a report that the received data is different from the request from the application, the report by the blockchain.

In the past, as represented by Japanese Patent No. 6514813, in the case where a data processing process such as score evaluation is executed on the basis of data collected from a data source, the data processing process is generally performed by a specific organization secured with predetermined authority and reliability.

However, in the case of a business structure in which plural autonomous organizations, rather than a specific single organization, cooperate to create open innovation, there is a need to perform a data processing process such as score evaluation in cooperation.

In the past, when data from a data source is provided to a service provider that processes data such as score evaluation, the data provider has no control over the distribution and handling of the data thereafter. On the other hand, in recent years, the adoption of a mechanism such as an information bank has changed the situation so that the data provider can regain the sovereignty of data.

However, in the system configuration of autonomous distributed cooperation as shown in Japanese Unexamined Patent Application Publication No. 2018-195154, data is opened among plural organizations, and is shared after securing trustworthiness by consensus building. Therefore, depending on the situation, there is a possibility that data is provided in violation of a data protection policy desired by the data provider as a result, or there is a possibility of causing a problem of subsequently violating the data protection policy.

Therefore, the present invention has been made in view of the above circumstances, and an object thereof is to provide a technique that enables compliance with a data protection policy defined in a data source when a data processing process is performed in cooperation with plural autonomous distributed organizations.

### SUMMARY

In order to solve the above-described problem, one aspect of the present invention provides a data management method in an information processing system including plural terminals, in which the terminal executes a data storage process in which the necessity of protection of data obtained from a predetermined data source is determined on the basis of a data protection policy provided from the data source, and in the case where it is determined that the data requires protection, a reference address of the data is stored into a first storage area through a predetermined cooperation process among the plural terminals, and correspondence information between the reference address and the data is stored into a second storage area without performing the cooperation process.

Another aspect of the present invention provides a data management system in an information processing system including plural terminals, in which the terminal executes a data storage process in which the necessity of protection of data obtained from a predetermined data source is determined on the basis of a data protection policy provided from the data source, and in the case where it is determined that the data requires protection, a reference address of the data is stored into a first storage area through a predetermined cooperation process among the plural terminals, and correspondence information between the reference address and the data is stored into a second storage area without performing the cooperation process.

Yet another aspect of the present invention provides a terminal configuring an information processing system, in which the terminal executes a data storage process in which the necessity of protection of data obtained from a predetermined data source is determined on the basis of a data protection policy provided from the data source, and in the case where it is determined that the data requires protection, a reference address of the data is stored into a first storage area through a predetermined cooperation process among the plural terminals, and correspondence information between the reference address and the data is stored into a second storage area without performing the cooperation process.

According to the present invention, it is possible to comply with a data protection policy defined in a data source when a data processing process is performed in cooperation with plural autonomous distributed organizations.

### BRIEF DESCRIPTION OF THE DRAWINGS

FIG. 1 is a block diagram for showing an outline configuration of a data management system in an embodiment;

FIG. 2 is a diagram for showing a data structure of a first pre-processing data table in the embodiment;

FIG. 3 is a diagram for showing a data structure of a second pre-processing data table in the embodiment;

FIG. 4 is a diagram for showing a data structure of a post-processed data table in the embodiment;

FIG. 5 is a diagram for showing a data structure of a table configuration management table in the embodiment;

FIG. 6 is a diagram for showing a data structure of data source actual data in the embodiment;

FIG. 7 is a diagram for showing a data structure of a data protection policy in the embodiment;

FIG. 8 is a diagram for showing a hardware configuration of a computer in the embodiment;

FIG. 9 is a diagram for showing a flow example of a data management method in the embodiment;

FIG. 10 is a diagram for showing a flow example of the data management method in the embodiment;

FIG. 11 is a diagram for showing a flow example of the data management method in the embodiment; and

FIG. 12 is a diagram for showing a flow example of the data management method in the embodiment.

### DETAILED DESCRIPTION OF THE EMBODIMENTS

### System Configuration

An embodiment of the present invention will be described below in detail using the drawings. It should be noted that the embodiment to be described below is not intended to limit the invention according to the scope of the claims, and all of the elements and combinations thereof described in the embodiment are not necessarily essential to the solving means of the invention.

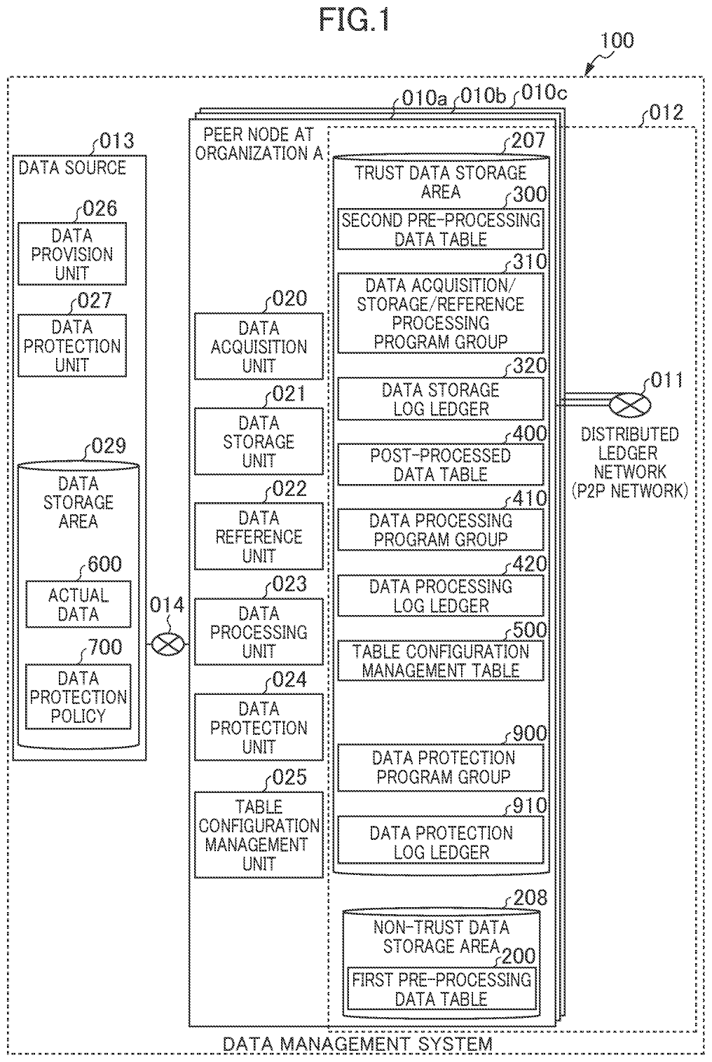

FIG. 1 is a diagram for showing a network configuration example of a data management system 100 of the embodiment. The data management system 100 shown in FIG. 1 is a computer system capable of complying with data protection policies defined by a data source when performing a data processing process in cooperation with plural autonomous distributed organizations. More specifically, a distributed ledger system that is configured using plural nodes is assumed as an example.

For example, it is assumed that the data management system of the embodiment provides, in a marketplace of application services, a service for scoring a credit score of an application service group handled by the marketplace. However, the embodiment is not limited to this form.

It is assumed that the above-described scoring of the application service is executed by applying activity history data (actual data 600) of an operator and the like of the application service, which is provided by an external data source 013, to a logic (a data processing program group 410 to be described below) that is managed in the system.

It is assumed that the activity history data (actual data 600) provided by the above-described data source 013 is managed by the service provider of the data source 013 in accordance with a data protection policy 700. On the other hand, such a scoring service in which the actual data 600 is provided from the data source 013, namely, the data management system 100 provides the scoring service utilizing the actual data 600 on the premise that it complies with the data protection policy 700 of the data source 013.

The data management system 100 that provides the scoring service is a system managed and operated by plural autonomous distributed organizations in a decentralized manner. The data management system 100 is configured using one or more peer nodes 010a, 010b, and 010c operated and managed by such plural autonomous distributed organizations and a distributed ledger network 011 (that is a peer-to-peer network) that mutually connects these peer nodes 010a, 010b, and 010c.

The peer nodes 010a, 010b, and 010c hold, in cooperation with each other, activity history data (data to be stored in a first pre-processing data table 200 and a second pre-processing data table 300 to be described below) collected from the data source 013, an acquisition/storage/reference history (storage history data to be stored in a data storage log ledger 320 to be described below) of the activity history data, score data (data to be stored in a post-processed data table 400 to be described below) obtained by calculating the activity history data using a score calculation logic (a data processing program group 410 to be described below), a score calculation history (history data to be stored in a data processing log ledger 420 to be described below), and a data protection history (history data to be stored in a data protection log ledger 910). The data is shared by the distributed ledger network 011.

As a preferred embodiment of such a technology for sharing a ledger by plural autonomous distributed organizations, provided is a blockchain technology that is a distributed ledger technology (see a data area configuration example 012 of a distributed ledger node in FIG. 1). The corresponding technologies are, for example, Hyperledger Fabric, Corda, and Quorum that are consortium-type blockchain implementations, and Ethereum that is a public-type blockchain implementation.

In Hyperledger Fabric, a data table on a trust data storage area 207 to be described below can be realized by the world state, a log ledger can be realized by a blockchain, a program group can be realized by a chain code and a smart contract, and the distributed ledger network 011 can be realized by a blockchain network. A non-trust data storage area 208 can be realized by a mechanism called private data or SideDB.

Accordingly, the tampering resistance of the ledger data on the trust data storage area 207 and the transparency of the ledger data/history and a program logic can be secured while sharing the ledger by plural autonomous distributed organizations.

It should be noted that each of the peer nodes 010a, 010b, and 010c includes a data acquisition unit 020, a data storage unit 021, a data reference unit 022, a data processing unit 023, a data protection unit 024, a table configuration management unit 025, a trust data storage area 207, and a non-trust data storage area 208.

The data acquisition unit 020 among these units is a processing unit that collects data from the external data source 013 via a network 014.

The data storage unit 021 is a processing unit that stores the data collected by the above-described data acquisition unit 020 into the trust data storage area 207 to be described below and the non-trust data storage area 208 to be described below.

The data collected by the data acquisition unit 020 is stored into the first pre-processing data table 200 to be described below and the second pre-processing data table 300 to be described below via the data storage unit 021. The storage history thereof is stored into the data storage log ledger 320 to be described below.

The data reference unit 022 is a processing unit that refers to the data stored in the trust data storage area 207 to be described below and the non-trust data storage area 208 to be described below. The data reference unit 022 refers to the data from the first pre-processing data table 200 to be described below, the second pre-processing data table 300 to be described below, and the post-processed data table 400 to be described below.

The data processing unit 023 refers to the data in the trust data storage area 207 to be described below and the non-trust data storage area 208 to be described below via the data reference unit 022, processes the data by executing the data processing program group 410 to be described below, and stores the data into the post-processed data table 400 via the data storage unit 021.

In order to comply with the data protection policy 700 when storing and processing the actual data 600 acquired from the data source 013 in the data management system 100, the data protection unit 024 is a processing unit that executes a data protection process for data stored in the trust data storage area 207 to be described below and the non-trust data storage area 208 to be described below.

The data protection unit 024 protects the actual data 600 and data derived from the actual data 600 in accordance with the above-described data protection policy 700. Regarding the data derived from the actual data 600, whether or not the data derived from the actual data 600 and stored in the first pre-processing data table 200 and the second pre-processing data table 300 and the data stored in the post-processed data table 400 comply with the data protection policy 700 is managed, and the data is controlled so as to comply with the data protection policy 700.

The data protection unit 024 executes a data protection program group 900 stored in the trust data storage area 207 at the time of the process of the above-described data protection. The execution history of the data protection process is stored in the data protection log ledger 910.

The table configuration management unit 025 is a processing unit that manages the correspondence between tables stored in the trust data storage area 207 and the non-trust data storage area 208. The table configuration management unit 025 manages the first pre-processing data table 200 to be described below and the second pre-processing data table 300 to be described below while being associated with each other.

It should be noted that the above-described trust data storage area 207 is a data storage area where data is shared among plural organizations participating in the distributed ledger network 011. The data stored in the trust data storage area 207 secures the data reliability (tampering resistance and transparency) among plural organizations (namely, among the peer nodes) participating in the same distributed ledger network 011.

The trust data storage area 207 includes the second pre-processing data table 300, a data acquisition/storage/reference processing program group 310, the data storage log ledger 320, the post-processed data table 400, the data processing program group 410, the data processing log ledger 420, a table configuration management table 500, the data protection program group 900, and the data protection log ledger 910.

Among these, the second pre-processing data table 300 is a table in which an entry of the actual data 600 acquired from the data source 013 or an entry of reference information for the actual data stored in the first pre-processing data table 200 to be described below is stored. It should be noted that the above-described storage history is stored in the data storage log ledger 320 to be described below, and the latest state of the distributed transaction execution result of the storage process is stored in the second pre-processing data table 300.

The data acquisition/storage/reference processing program group 310 includes an acquisition processing program of the data acquisition unit 020, a data storage processing program of the data storage unit 021, and a reference processing program of the data reference unit 022. In the case of configuring the data management system 100 with a blockchain, the program group 310 stored in the trust data storage area 207 is realized by a chain code and a smart contract deployed and instantiated with the consensus building of plural organizations participating in the distributed ledger network 011, and the storage history of the data is added to and stored into the data storage log ledger 320 to be described below as block information.

The data storage log ledger 320 is a ledger that stores the history of the data storage process by the data storage unit 021. In the case where the data management system 100 is configured using a blockchain, the blocks that contain the history is added in a chain form, and the ledger history is stored.

In the post-processed data table 400, the data of the first pre-processing data table 200 and the data of the second pre-processing data table 300 are read by the data processing unit 023, and the processed data obtained by executing a processing process of the data processing program group 410 is stored.

In the embodiment in which the scoring service for an application service group is assumed, score information for each application service that is a result of the calculation by the score calculation logic (the data processing program group 410 to be described below) on the basis of the activity history data (the data stored in the first pre-processing data table and the second pre-processing data table) is stored in the post-processed data table 400. In the case of configuring the data management system 100 with a blockchain, the post-processed data table 410 can be realized as the world state that stores the latest execution result of the distributed transaction.

The data processing program group 410 is data processing programs of the data processing unit 023. In the case of configuring the data management system 100 with a blockchain, the data processing program is realized by a chain code and a smart contract deployed and instantiated with the consensus building of plural organizations participating in the distributed ledger network 011, the storage history of the data is added to and stored into the data processing log ledger 420 to be described below as block information.

The data processing log ledger 420 is a ledger that stores the data processing history of the data processing unit 023. In the case of configuring the data management system 100 with a blockchain, the blocks of the data processing history are added in a chain form to form the ledger history.

It should be noted that in the case of configuring the data management system 100 with a blockchain, the data protection program group 900 stored in the trust data storage area 207 is realized by a chain code and a smart contract deployed and instantiated with the consensus building of plural organizations participating in the distributed ledger network 011. The storage history of the data is added to and stored into the data protection log ledger 910 to be described below as block information. The data protection program group 900 is protection processing programs of the data protection unit 024.

The table configuration management table 500 is a table that defines the correspondence between the tables managed by the table configuration management unit 025. In the case of configuring the data management system 100 with a blockchain, it is possible to realize as the world state that stores the latest execution result of the distributed transaction.

The trust data storage area 207 is a data storage area that is shared among plural organizations participating in the distributed ledger network 011 through a predetermined collaborative process such as consensus building. On the other hand, the data stored in the non-trust data storage area 208 does not secure the data reliability (tampering resistance and transparency) among plural organizations participating in the same distributed ledger network 011. Namely, the data can be deleted, and the data before the deletion does not remain in the non-trust data storage area 208. It is not possible to refer to the deleted data after deleting the data. In the case of configuring the data management system 100 with a blockchain, the non-trust data storage area 208 can be configured with Privatedata or SideDB.

The data source 013 is an information processing device (for example, a server device) that provides the actual data 600 from which the pre-processing data (each data in the first pre-processing data table 200 and the second pre-processing data table 300) is acquired to the peer node 010. The scoring service indicated by the embodiment provides the source data (actual data 600) of the activity history data (each data in the first pre-processing data table 200 and the second pre-processing data table 300) on the basis of which the score is calculated.

The above data source 013 can be assumed to be operated and managed by an organization different from the one that operates and manages the peer nodes 010a, 010b, and 010c. However, the embodiment is not limited to this form, and a form that is common to some of operation organizations of each peer node 010 can also be assumed. In any case, the data source 013 provides (to the peer node 010) the actual data 600 on the condition of complying with the data protection policy 700 regarding retention and utilization of data for the operators of the peer node 010.

Such a data source 013 includes a data provision unit 026, a data protection unit 027, and a data storage area 029.

Among these, the data provision unit 026 is a processing unit that provides the actual data 600 and the data protection policy 700 thereof in response to a data acquisition request from the data acquisition unit 020.

The data protection unit 027 is a processing unit that protects the actual data 600 in accordance with the data protection policy 700 and the data derived from the actual data 600. In the protection of the data derived from the actual data 600, whether or not the data derived from the actual data 600 and stored in the first pre-processing data table 200 and the second pre-processing data table 300 and the data stored in the post-processed data table 400 comply with the data protection policy 700 is managed, and the data is controlled so as to comply with the data protection policy 700.

The data storage area 029 is a storage area in storage means that stores each data held by the data source 013. In the data storage area 029, the actual data 600 and the data protection policy 700 are stored.

Among these, the actual data 600 is data provided by the data source 013 to the peer node 010. The actual data 600 in the embodiment corresponds to, for example, the activity history data of the developers and users of an application and the activity history data related to the application, which are the basis of the scoring calculation. On the other hand, the data protection policy 700 stores the data protection policy of the actual data 600. A concrete example of the data protection policy 700 will be described later.

### Example of Data Structure

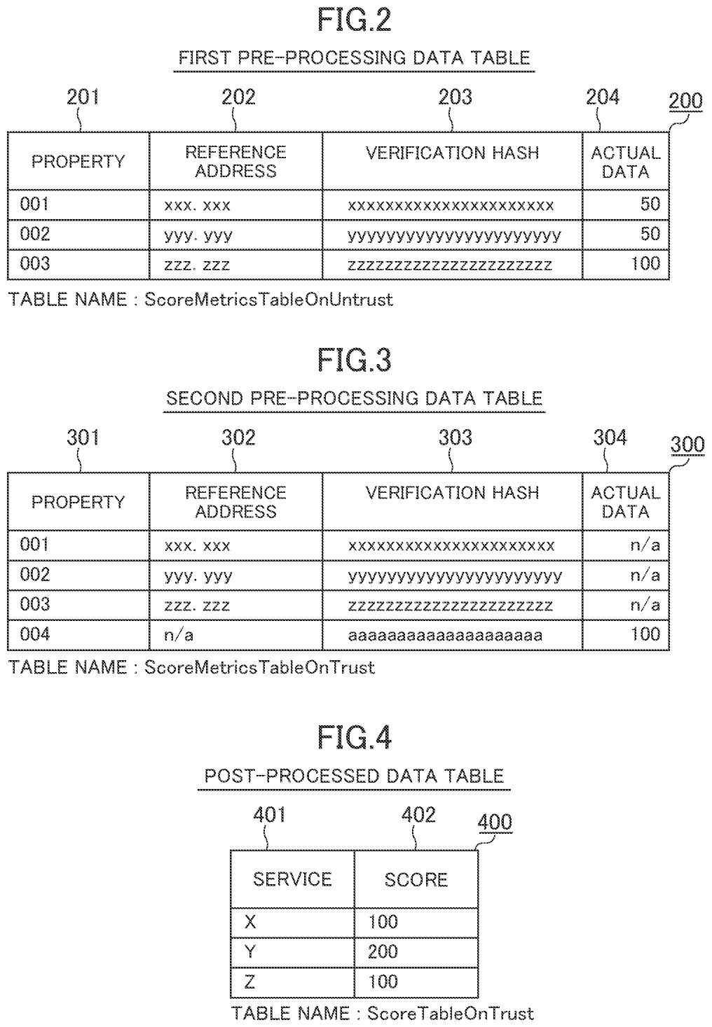

Next, concrete examples of various tables and information used for the data management system 100 of the embodiment will be described. FIG. 2 shows an example of a data structure of the first pre-processing data table 200 in the embodiment.

The first pre-processing data table 200 is managed by being given a uniquely identifiable name. For example, it is assumed to be managed by a table name such as “ScoreMetricsTableOnUntrust”.

The first pre-processing data table 200 exemplified in FIG. 2 includes a property column 201, a reference address column 202, a verification hash column 203, and an actual data column 204.

Among these, the property column 201 stores attribute information of data. As the attribute information, for example, a data name and a number, the size of the data, a registrant, the date and time of registration, the purpose of use, and various other information can be assumed.

The reference address column 202 stores address information where the corresponding actual data 600 is stored. The address information can be assumed as an IP address that uniquely identifies the area of the data source 013 in the data storage area 029, or an IP address that uniquely identifies the area where the actual data 600 and the derived data thereof are stored in a specific peer node 010 holding the actual data 600 and the derived data thereof.

The verification hash column 203 stores hash information for verifying the authenticity of the corresponding actual data 600. The actual data column 204 stores the corresponding actual data value or the corresponding actual data contents.

Next, FIG. 3 shows an example of a data structure of the second pre-processing data table 300 in the embodiment. As similar to the above-described first pre-processing data table 200, the second pre-processing data table 300 is managed by being given a uniquely identifiable name. For example, the second pre-processing data table 300 of the embodiment is stored by a table name such as “ScoreMetricsTableOnTrust”.

Such a second pre-processing data table 300 includes a property column 301, a reference address column 302, a verification hash column 303, and an actual data column 304.

Among these, the property column 301 stores attribute information of data. A concrete example of the attribute information is the same as that of the above-described first pre-processing data table 200.

The reference address column 302 stores address information where the actual data 600 is stored. A concrete example of the address information is also the same as that of the above-described first pre-processing data table 200. It should be noted that in the case where the entry is an actual data entry, namely, the entry contains data to which any special data protection policy need not be applied and which can be shared among the peer nodes 010 as it is, an actual data value or actual data contents are stored in the actual data column 304. Therefore, no information is stored in the reference address column 302 of the entry.

The verification hash column 303 stores hash information for verifying the authenticity of the corresponding actual data 600. In the case where the entry is an actual data entry storing actual data, the actual data column 304 stores an actual data value or actual data contents. On the other hand, in the case where the entry is a reference data entry that does not store actual data but stores only reference data, the actual data column 304 stores no information.

Next, FIG. 4 shows an example of a data structure of the post-processed data table 400 in the embodiment. The post-processed data table 400 in the embodiment stores a credit score value aggregated for each application service (that may include the concept of the operator of the application service). The table is stored by a uniquely identifiable name, and is managed by being given a table name, for example, ScoreTableOnTrust.

The post-processed data table 400 of the embodiment exemplified in FIG. 4 includes, for example, a service column 401 and a score column 402. Among these, the service column 401 stores ID information that uniquely identifies the application service. The score column 402 stores the credit score value of the application service.

Next, FIG. 5 shows an example of a data structure of the table configuration management table 500 in the embodiment. The table configuration management table 500 of the embodiment shown in FIG. 5 includes, for example, an ID column 501, a logical table name column 502, a trust data storage area actual table name column 503, and a non-trust data area actual table name column 504.

Among these, the ID column 501 stores identification information that uniquely identifies the correspondence between a table held by the trust data storage area 207 and a table of the corresponding non-trust data storage area 208.

The logical table name column 502 stores table identification information in the case where the tables that are stored in the trust data storage area 207 and the non-trust data storage area 208 and can be or cannot be referred to by each other are joined together and are regarded as one abstracted logical table irrespective of a storage area.

The trust data storage area actual table name column 503 stores identification information of the table that configures one logical table and is stored in the trust data storage area 207. On the other hand, the non-trust data area actual table name column 504 stores identification information of the table that configures the table defined by the trust data storage area actual table name column 503 and one logical table and is stored in the non-trust data storage area 208.

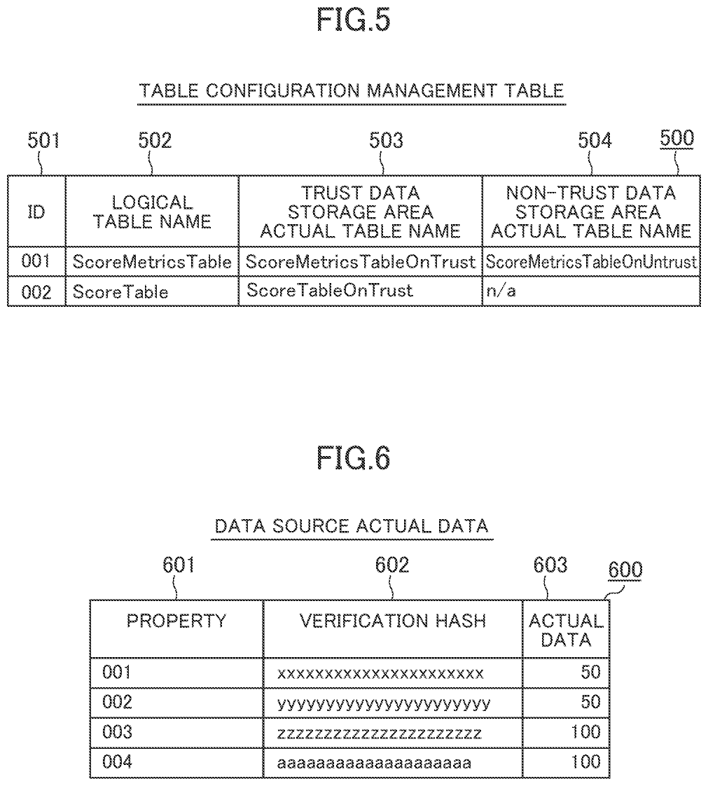

Next, FIG. 6 shows an example of a data structure of the data source actual data 600 in the embodiment. The data source actual data 600 is a table held by the data source 013, and is a collection of data that can be provided to the peer node 010 on the basis of the data protection policy 700. The data source actual data 600 includes, for example, a property column 601, a verification hash column 602, and an actual data column 603.

Among these, the property column 601 stores attribute information of the actual data. The attribute information is the same as that in the first pre-processing data table 200 and the second pre-processing data table 300.

The verification hash column 602 stores hash information for verifying the authenticity of the corresponding actual data. The actual data column 603 stores actual data values.

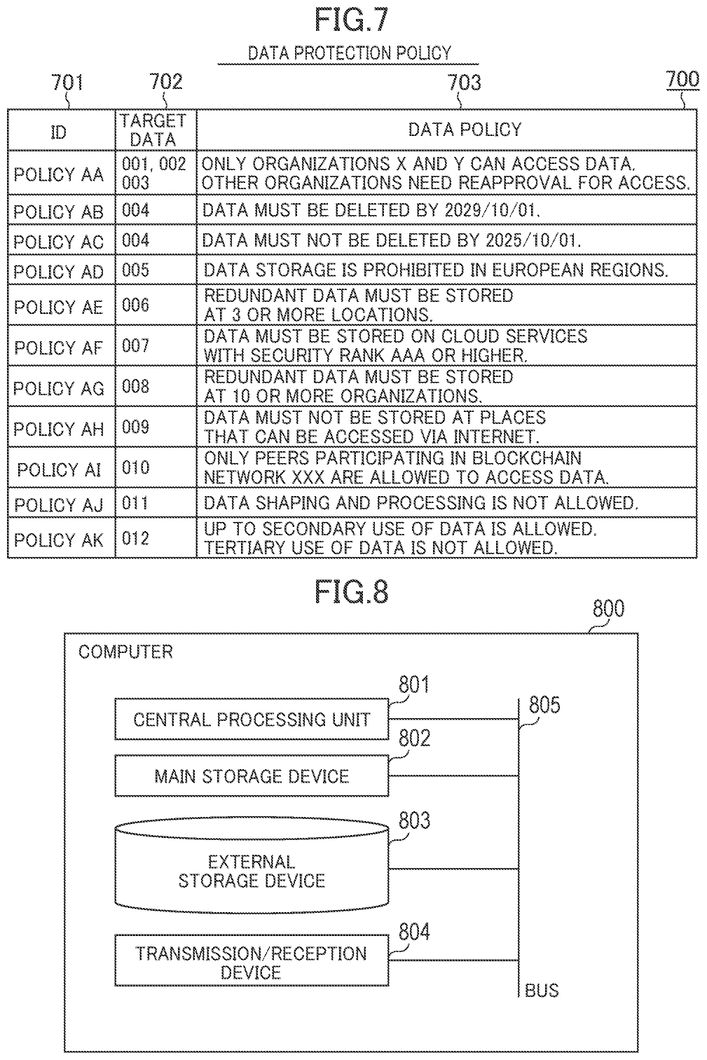

Next, FIG. 7 shows an example of a data structure of the data protection policy 700 in the embodiment. The data protection policy 700 in the embodiment is a table that is held by the data source 013 and that stores policies for determining and controlling whether or not the actual data of the data source actual data 600 is to be provided to the peer node 010 and the contents to be provided.

The data protection policy 700 includes, for example, an ID column 701, a target data column 702, and a data policy column 703.

Among these, the ID column 701 stores an ID that uniquely identifies the corresponding data protection policy. The target data column 702 stores identification information (the value of the property column 601 in the entry of the data source actual data 600) of data to which the data protection policy applies. The data policy column 703 stores the contents of the data protection policy.

### Hardware Configuration

Next, a hardware configuration example of the peer node 010 and the data source 013 in the embodiment will be described. FIG. 8 is a diagram for showing a configuration example of a computer in the embodiment. The computer shown in the drawing configures the peer node 010 and the data source 013.

A computer 800 exemplified in the drawing includes a central processing unit 801, a main storage device 802, an external storage device 803, a transmission/reception device 804, and a bus 805. The central processing unit 801, the main storage device 802, the external storage device 803, and the transmission/reception device 804 are connected to each other through the bus 805.

Among these, the central processing unit 801 is hardware that controls operations in the computer, and is specifically a CPU (Central Processing Unit).

The main storage device 802 is configured using, for example, a semiconductor memory, and temporarily holds various programs and control data to realize the data acquisition unit 020, the data storage unit 021, the data reference unit 022, the data processing unit 023, the data protection unit 024, the table configuration management unit 025, the data provision unit 026, and the data protection unit 027.

The external storage device 803 is a storage device having a large storage capacity, and is, for example, a hard disk device or an SSD (Solid State Drive). The external storage device 803 can hold execution files, tables, ledgers, and the like of various programs. The main storage device 802 and the external storage device 803 are accessible from the central processing unit 801.

Such an external storage device 803 included in the computer 800 configuring the peer nodes 010a, 010b, and 010c logically configures the trust data storage area 207 and the non-trust data storage area 208, each of which stores the second pre-processing data table 300, the data acquisition/storage/reference processing program group 310, the data storage log ledger 320, the post-processed data table 400, the data processing program group 410, the data processing log ledger 420, the table configuration management table 500, the data protection program group 900, the data protection log ledger 910, and the first pre-processing data table 200.

On the external storage device 803 included in the computer 800 realizing the data source 013, the data storage area 029 is logically realized, and the actual data 600 and the data protection policy 700 are stored in the data storage area 029.

The transmission/reception device 804 is hardware having a function of controlling communications with the outside. The transmission/reception device 804 can transmit and receive data via the Internet, a closed network, or a local network line.

### Flow Example: Process by Data Storage Unit

Hereinafter, an actual procedure of a data management method in the embodiment will be described on the basis of the drawing. The various operations corresponding to the data management method described below are realized by a program that is read into a memory to be executed by the peer node 010 and the data source 013 configuring the data management system 100. Further, the program is configured using codes to perform various operations to be described below.

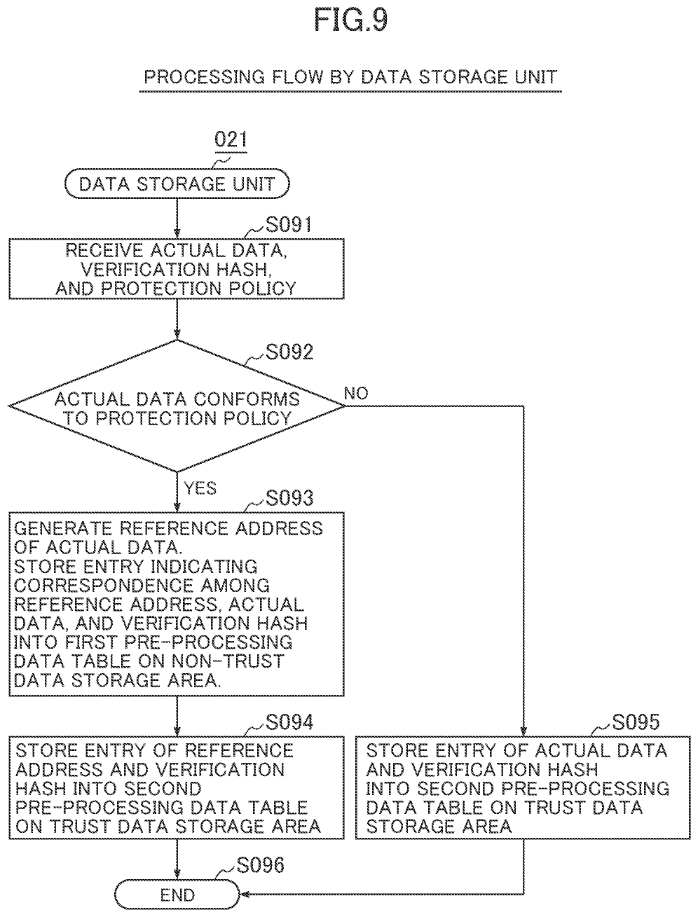

FIG. 9 shows a flow example of the data management method in the embodiment, and is specifically a diagram for showing a flow of a data storage process by the data storage unit 021 in the peer node 010. Here, the data storage unit 021 receives the actual data 600, the verification hash, and the data protection policy 700 from the data source 013 (or other peer nodes) (S091).

Next, the data storage unit 021 determines whether the actual data 600 received in Step S091 described above and the user thereof, that is, the operator of the peer node 010 conforms to the data protection policy 700 (S092). This determination is, for example, a process of determining whether or not various requirements are satisfied, such as whether or not the attributes of the operator of the peer node 010 (for examples, the organization name, size, affiliated organization, type of business, location, and the like. The peer node 010 naturally holds the information in advance) match those specified in the data protection policy 700.

As a result of the determination in Step S092 described above, in the case where it is determined that the attributes of the actual data 600 and the like conform to the data protection policy 700 (S092: YES), the data storage unit 021 generates the reference address of the actual data 600 (S093). This reference address can be assumed to be, for example, the address of the area reserved as the storage destination of the actual data in the non-trust data storage area 208.

In Step S093 described above, the data storage unit 021 stores an entry indicating the correspondence among the reference address, the actual data obtained in S091, and the verification hash into the first pre-processing data table 200 of the non-trust data storage area 208.

Next, the data storage unit 021 stores the entry including the above-described reference address and verification hash into the second pre-processing data table 300 of the trust data storage area 207 (S904), and terminates the process.

On the other hand, as a result of the determination in Step 902 described above, in the case where it is determined that the attributes of the actual data 600 and the like do not conform to the data protection policy 700 (S092: NO), the data storage unit 021 stores the entry of the actual data 600 and the verification hash into the second pre-processing data table 300 (Step 095), and terminates the processing.

### Flow Example: Process by Data Reference Unit

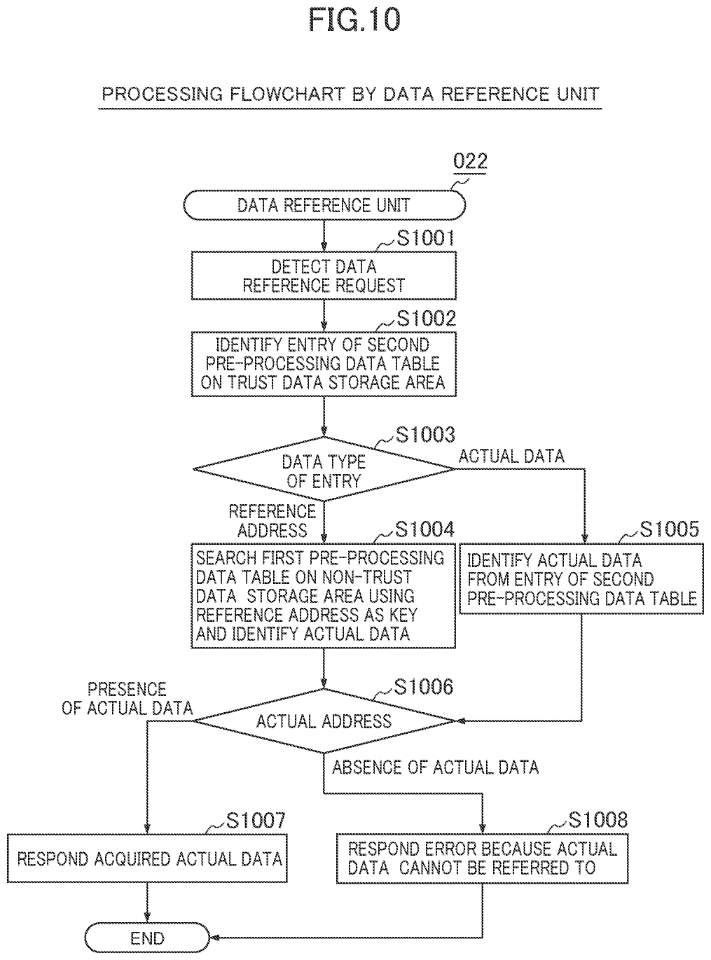

FIG. 10 is a diagram for showing a flow example of the data management method in the embodiment, and is specifically a diagram for showing a flow of a data reference process by the data reference unit 022. In this case, the data reference unit 022 of a peer node 010 detects, for example, a data reference request from another peer node 010 or a client terminal connected to the peer node 010 (S1001).

Next, the above-described data reference unit 022 performs a search in the second pre-processing data table 300 on the trust data storage area 207 on the basis of a predetermined data attribute (for example, the value of the property) indicated by the data reference request received in S1001, and identifies an entry corresponding to the above-described data reference request (S1002).

The above-described data reference unit 022 determines the data type of the entry identified in Step S1002 described above (S1003). The data type of the entry is the type of an actual data entry storing the actual data 600 or a reference data entry storing the reference address.

As a result of the determination in Step S1003 described above, in the case where the data type of the entry is the reference data entry (S1003: reference address), the data reference unit 022 searches the first pre-processing data table 200 on the non-trust data storage area 208 using the reference address as a key, and identifies the actual data entry storing the actual data (S1004).

On the other hand, as a result of the determination in Step S1003 described above, in the case where the data type of the entry is the actual data entry (S1003: actual data), the data reference unit 022 identifies the actual data from the actual data entry in the second pre-processing data table 300 identified in Step 1002 described above (Step 1005).

After identifying the actual data in Step S1004 or Step S1005 described above, the data reference unit 022 determines whether or not the actual data exists (Step 1006). In the flow of Step S1004, in the case where the first pre-processing data table 200 on the non-trust data storage area 208 is accessed by specifying the reference address and the actual data 600 can be acquired, it is determined that the actual data exists. In the flow of Step S1005, in the case where the second pre-processing data table 300 on the trust data storage area 207 is accessed and the actual data 600 can be acquired from the entry, it is determined that the actual data exists.

It should be noted that in the case where the actual data does not exist, a case in which the actual data entry cannot be identified in Step S1004 or Step S1005 is included.

In the case where the actual data exists as a result of the determination in Step S1006 described above (S1006: presence of actual data), the data reference unit 022 sends the identified actual data 600 to the request source (the peer node 010) of the data reference request received in Step 1001 (S1007), and terminates the process.

On the other hand, in the case where the actual data does not exist as a result of the determination in Step S1006 described above (S1006: absence of actual data), the data reference unit 022 responds, to the request source of the data reference request received in Step S1001, the fact that the actual data could not be referred to (S1008), and terminates the process.

It should be noted that as a case in which the reference address exists in Step S1004 and the actual data cannot be referred to in Step S1008, there is, for example, a case in which the actual data is deleted after the execution of the data protection policy 700. In this case, for example, in the case where a violation of the data protection policy 700 is found after the fact, the actual data stored in the non-trust data storage area 208 can be deleted to achieve both compliance with the data protection policy and the consensus building process or distributed transaction execution process required by the trust data storage area 207 for ensuring data sharing and data reliability.

### Flow Example: Process by Data Processing Unit

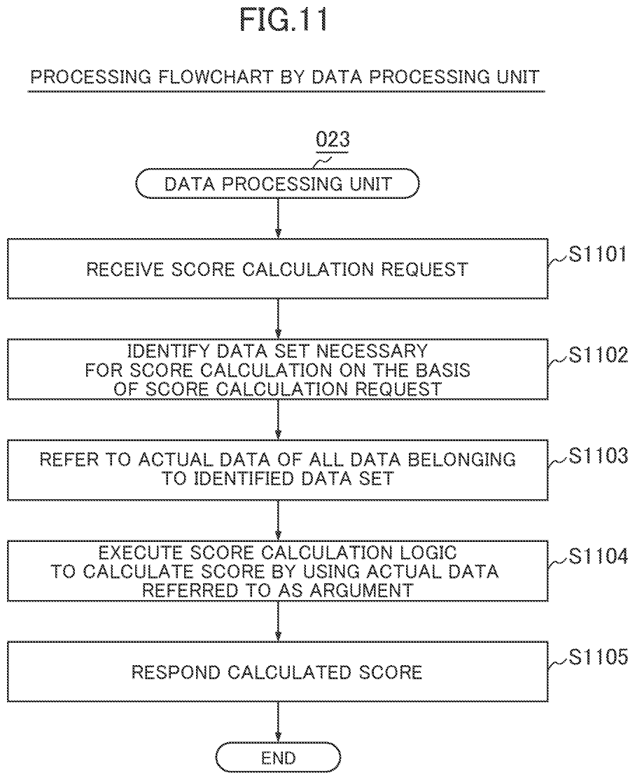

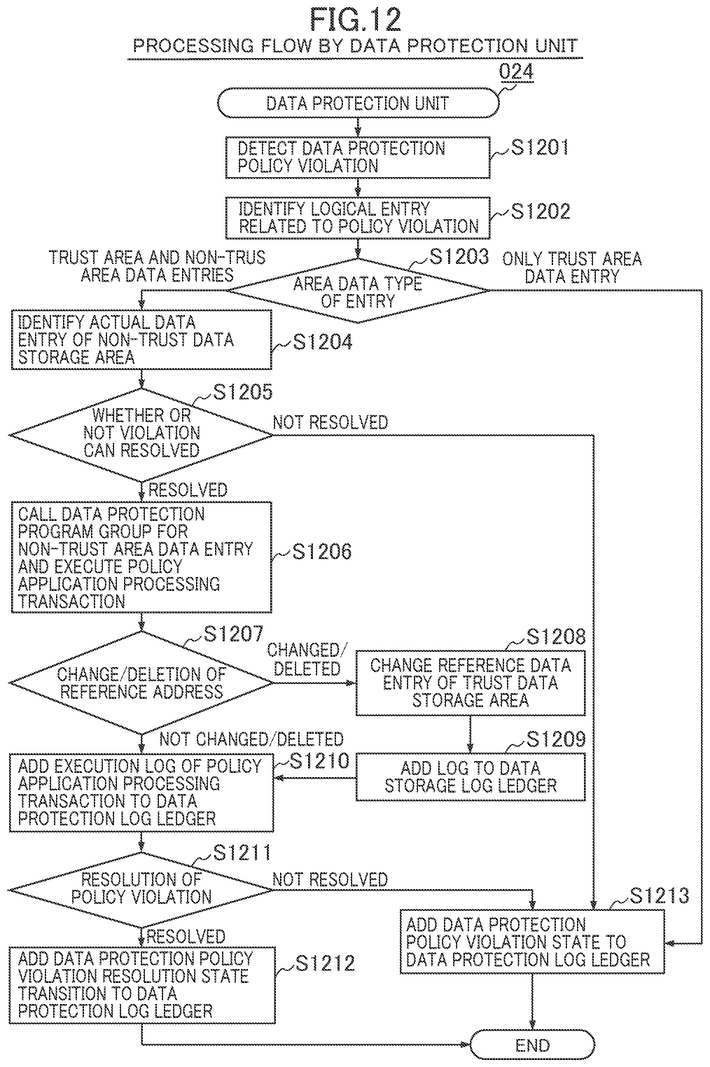

FIG. 11 shows a flow example of the data management method in the embodiment, and is specifically a diagram for showing a score calculation processing flow by the data processing unit 023.

In this case, the data processing unit 023 in the peer node 010 receives a score calculation request from, for example, another peer node or a client terminal connected to the peer node 010 (S1101).

Next, the data processing unit 023 identifies a data set necessary for the score calculation from the score calculation request received in Step S1101 described above (S1102). Therefore, it is assumed that necessary conditions of the data set are specified in the score calculation request. Specifically, the specification of the property of the actual data or the derived data thereof, namely, the specification of the attribute is included.

Next, the data processing unit 023 refers to the actual data of each data belonging to the data set identified in Step S1102 described above (S1103). This reference process is executed by the data reference unit 022 as similar to the flow of FIG. 10, and the result of the data reference unit 022 is acquired.

The data processing unit 023 executes the score calculation logic of the data processing program group 410 to calculate a score by using the actual data referred to in Step S1103 as an argument (S1104). The score calculation logic is not particularly limited, and can be assumed to be a mathematical expression or the like in which plural variables having the actual data as an argument are combined with a predetermined arithmetic element.

Then, the data processing unit 1105 sends the score calculated in Step S1104 to the request source (the peer node or the like) of the score calculation request received in Step 1101 (S1105), and terminates the process.

### Flow Example: Process by Data Protection Unit

FIG. 12 shows a flow example of the data management method in the embodiment, and is specifically a diagram for showing a data protection processing flow by the data protection unit 024.

In this case, the data protection unit 024 of the peer node 010 detects a violation of the data protection policy (S1201). This detection can be assumed to be, for example, a process of verifying the conditions specified in the data protection policy 700 (for example: limiting a person who can use the data among the operators of the peer node 010, the expiration date of the data, the expiration date of deletion, and the like) with various situations in the distributed ledger network 011 (for example, the configuration of each peer node 010, and the like).

Next, the data protection unit 024 identifies a logical entry related to the violation of the data protection policy detected in Step S1201 described above (S1202). This identification process can be executed by extracting the value of the target data column 702 in the entry of the data protection policy as a target to be detected in Step S1201.

Next, the data protection unit 024 determines the area data type of the logical entry identified in Step S1202 described above (S1203). That is, the data protection unit 024 determines whether the data of the logical entry is the type of data configured using the reference data entry stored in the trust data storage area 207 and the actual data entry stored in the non-trust data storage area 208, or the type of data configured using the actual data entry stored in the trust data storage area 207.

As a result of the data type determination in Step S1203 described above, in the case where it is determined that the data is configured using the actual data entry stored in the trust data storage area 207 (S1203: only the trust area data entry), the process proceeds to Step S1213 described below.

On the other hand, as a result of the data type determination in Step S1203 described above, in the case where the data of the logical entry is data consisting of the reference data entry stored in the trust data storage area 207 and the actual data entry stored in the non-trust data storage area 208 (S1203: the trust area and non-trust area data entries), the data protection unit 024 searches the first pre-processing data table 200 on the non-trust data storage area 208 to identify the data entry storing the actual data (S1204).

The data protection unit 024 verifies the contents of the actual data identified in Step S1204 described above with the data protection policy 700 to determine whether or not the violation related to the data protection policy 700 can be resolved (Step 1205). For example, in the case where the conditions specified in the data protection policy 700 designates an operator who can use the data, this determination can be assumed as whether or not the data of the non-trust data storage area 208 can be deleted by the peer node 010, which has come to hold the actual data in the violation state so as to satisfy the conditions.

In the case where it is determined that the violation cannot be resolved as a result of the determination in Step S1205 described above (S1205: not resolved), the data protection unit 024 advances the process to Step 1213 to be described below.

On the other hand, in the case where it is determined that the violation can be resolved as a result of the determination in Step S1205 described above, the data protection unit 024 calls the data protection program group 900 for the data entry on the first pre-processing data table 200 stored in the non-trust data storage area 208, and executes a policy application processing transaction (S1206). The policy application process applies an algorithm for executing a resolution method corresponding to the determination of the resolution made in Step S1205 described above to the data. The transaction is a transaction issued in accordance with a series of consensus building processes in the distributed ledger network 011.

Next, the data protection unit 024 determines whether the reference address needs to be changed or deleted as a result of the execution of the above-described data protection policy application processing transaction (S1207). This determination corresponds to a situation where the storage destination of the actual data has changed in accordance with the execution of the data protection policy application processing transaction, namely, the reference address has changed.

In the case where the reference address needs to be changed or deleted as a result of the determination in Step S1207 described above (S1207: changed/deleted), the data protection unit 024 identifies the reference data entry of the data on the second pre-processing data table 300 on the trust data storage area 207, and changes or deletes the reference data entry (S1208).

Next, the data protection unit 024 adds a history of changing or deleting the reference data entry to the data storage log ledger 320 in accordance with Step S1208 described above, and advances the process to Step S1210 described below (S1209).

On the other hand, in the case where the reference address does not need to be changed or deleted as a result of the determination in Step S1207 described above (S1207: not changed/deleted), the data protection unit 024 advances the process to Step 1210.

The data protection unit 024 adds the execution log of the policy application processing transaction to the data protection log ledger 910 in accordance with Step S1206 described above (S1210).

The data protection unit 024 determines whether or not the policy violation has been resolved as a result of executing the data protection policy application processing transaction (S1211). This determination is made again in the same manner as in Step 1201.

In the case where the policy violation has not been resolved as a result of the determination in Step S1211 described above (S1211: not resolved), the data protection unit 024 advances the process to Step S1213 described below.

On the other hand, in the case where the policy violation has been resolved as a result of the determination in Step S1211 described above (S1211: resolved), the data protection unit 024 adds the transition to a data protection policy violation resolution state to the data protection log ledger 910 as a history (S1212), and terminates the process.

It should be noted that in the case where the data protection policy violation cannot be resolved as a result of each determination in Steps S1203, S1205, and S1211 described above, the data protection unit 024 adds the fact that the data protection policy violation state cannot be resolved to the data protection log ledger 910 as a history (S1213), and terminates the process. With this history information as an opportunity, a report is issued to the organization of the data source, or an incident requesting measures from the administrator of the organization participating in the distributed ledger network 011 is issued.

Although the best mode for carrying out the present invention has been concretely described above, the present invention is not limited thereto, and can be variously changed without departing from the gist thereof.

According to such an embodiment, it is possible to comply with a data protection policy defined in a data source when a data processing process is performed in cooperation with plural autonomous distributed organizations.

At least the following is clarified by the description of this specification. Namely, in the case where the data is data that need not be protected as a result of the determination of the necessity of protection at the time of the data storage process, the terminal may store the data into the first storage area through the cooperation process in the data management method of the embodiment.

According to this, if the data can be shared among the respective terminals configuring the information processing system, the data can be efficiently held by the respective terminals without performing any special process, and can be referred to and used by the respective terminals at any time.

In the data management method of the embodiment, the terminal may execute a data reference process in which in the case where a data reference request is received from the other terminal, an entry is identified in the first storage area on the basis of a data attribute indicated by the reference request to search the second storage area using a data reference address indicated by the entry as a key, and in the case where the data can be identified, the data is returned to the other terminal.

According to this, while each data can be appropriately managed according to the data protection policy, an operator of the terminal that meets the conditions can efficiently use the data.

In the data management method of the embodiment, the terminal identifies an entry in the first storage area on the basis of the data attribute indicated by the reference request at the time of the data reference process, and in the case where the entry contains the data, the data may be sent to the other terminal.

According to this, the data that is held by the respective terminals as data that can be shared among the respective terminals configuring the information processing system can be efficiently used by the respective terminals without performing any special process

In the data management method of the embodiment, the terminal may execute a score calculation process in which a data set necessary to execute a predetermined evaluation algorithm for at least any one of operators of the respective terminals is identified by the data reference process, and an evaluation score is calculated by applying each data contained in the data set to the evaluation algorithm.

According to this, the evaluation score of the operator of each terminal included in the information processing system is calculated in compliance with the data protection policy, and the evaluation score as the calculation result can be appropriately shared among the terminals.

In the data management method of the embodiment, the terminal may execute a data protection control process in which in the case where a violation state of the data protection policy is identified by verifying predetermined attribute information related to the information processing system with conditions specified by the data protection policy, the first and second storage areas are searched for an entry related to the data protection policy, and a predetermined process is executed for an entry that can resolve the violation state by the predetermined process for the data held in the second storage area among those that can be identified in the first and second storage areas.

According to this, with a change in the situation such as an increase or decrease in the number of operators of the terminals configuring the information processing system, the entry that violates the data protection policy can be automatically corrected to resolve the violation.

In the data management system of the embodiment, in the case where the data is data that need not be protected as a result of the determination of the necessity of protection at the time of the data storage process, the terminal may store the data into the first storage area through the cooperation process.

In the data management system of the embodiment, the terminal may execute a data reference process in which in the case where a data reference request is received from the other terminal, an entry is identified in the first storage area on the basis of a data attribute indicated by the reference request to search the second storage area using a data reference address indicated by the entry as a key, and in the case where the data can be identified, the data is sent to the other terminal.

In the data management system of the embodiment, the terminal identifies an entry in the first storage area on the basis of the data attribute indicated by the reference request at the time of the data reference process, and in the case where the entry contains the data, the data may be sent to the other terminal.

In the data management system of the embodiment, the terminal may execute a score calculation process in which a data set necessary to execute a predetermined evaluation algorithm for at least any one of operators of the respective terminals is identified by the data reference process, and an evaluation score is calculated by applying each data contained in the data set to the evaluation algorithm.

In the data management system of the embodiment, the terminal may execute a data protection control process in which in the case where a violation state of the data protection policy is identified by verifying predetermined attribute information related to the information processing system with conditions specified by the data protection policy, the first and second storage areas are searched for an entry related to the data protection policy, and a predetermined process is executed for an entry that can resolve the violation state by the predetermined process for the data held in the second storage area among those that can be identified in the first and second storage areas.

What is claimed is:

1. A data management method in an information processing system including plural terminals,
wherein the terminal executes a data storage process in which the necessity of protection of data obtained from a predetermined data source is determined on the basis of a data protection policy provided from the data source, and in the case where it is determined that the data requires protection, a reference address of the data is stored into a first storage area through a predetermined cooperation process among the plural terminals, and correspondence information between the reference address and the data is stored into a second storage area without performing the cooperation process.

2. The data management method according to claim 1,
wherein in the case where the data is data that need not be protected as a result of the determination of the necessity of protection at the time of the data storage process, the terminal stores the data into the first storage area through the cooperation process.

3. The data management method according to claim 1,
wherein the terminal executes a data reference process in which in the case where a data reference request is received from the other terminal, an entry is identified in the first storage area on the basis of a data attribute indicated by the reference request to search the second storage area using a data reference address indicated by the entry as a key, and in the case where the data can be identified, the data is sent to the other terminal.

4. The data management method according to claim 3,
wherein the terminal identifies an entry in the first storage area on the basis of the data attribute indicated by the reference request at the time of the data reference process, and in the case where the entry contains the data, the data is sent to the other terminal.

5. The data management method according to claim 3,
wherein the terminal executes a score calculation process in which a data set necessary to execute a predetermined evaluation algorithm for at least any one of operators of the respective terminals is identified by the data reference process, and an evaluation score is calculated by applying each data contained in the data set to the evaluation algorithm.

6. The data management method according to claim 1,
wherein the terminal executes a data protection control process in which in the case where a violation state of the data protection policy is identified by verifying predetermined attribute information related to the information processing system with conditions specified by the data protection policy, the first and second storage areas are searched for an entry related to the data protection policy, and a predetermined process is executed for an entry that can resolve the violation state by the predetermined process for the data held in the second storage area among those that can be identified in the first and second storage areas.

7. A data management system in an information processing system including plural terminals,
wherein the terminal executes a data storage process in which the necessity of protection of data obtained from a predetermined data source is determined on the basis of a data protection policy provided from the data source, and in the case where it is determined that the data requires protection, a reference address of the data is stored into a first storage area through a predetermined cooperation process among the plural terminals, and correspondence information between the reference address and the data is stored into a second storage area without performing the cooperation process.

8. The data management system according to claim 7,
wherein in the case where the data is data that need not be protected as a result of the determination of the necessity of protection at the time of the data storage process, the terminal stores the data into the first storage area through the cooperation process.

9. The data management system according to claim 7,
wherein the terminal executes a data reference process in which in the case where a data reference request is received from the other terminal, an entry is identified in the first storage area on the basis of a data attribute indicated by the reference request to search the second storage area using a data reference address indicated by the entry as a key, and in the case where the data can be identified, the data is sent to the other terminal.

10. The data management system according to claim 9,
wherein the terminal identifies an entry in the first storage area on the basis of the data attribute indicated by the reference request at the time of the data reference process, and in the case where the entry contains the data, the data is sent to the other terminal.

11. The data management system according to claim 9,
wherein the terminal executes a score calculation process in which a data set necessary to execute a predetermined evaluation algorithm for at least any one of operators of the respective terminals is identified by the data reference process, and an evaluation score is calculated by applying each data contained in the data set to the evaluation algorithm.

12. The data management system according to claim 7,
wherein the terminal executes a data protection control process in which in the case where a violation state of the data protection policy is identified by verifying predetermined attribute information related to the information processing system with conditions specified by the data protection policy, the first and second storage areas are searched for an entry related to the data protection policy, and a predetermined process is executed for an entry that can resolve the violation state by the predetermined process for the data held in the second storage area among those that can be identified in the first and second storage areas.

13. A terminal configuring an information processing system,
wherein the terminal executes a data storage process in which the necessity of protection of data obtained from a predetermined data source is determined on the basis of a data protection policy provided from the data source, and in the case where it is determined that the data requires protection, a reference address of the data is stored into a first storage area through a predetermined cooperation process among the plural terminals, and correspondence information between the reference address and the data is stored into a second storage area without performing the cooperation process.
